(19) United States
(12) Patent Application Publication
(10) Pub. No.: US 2020/0141789 A1
(43) Pub. Date: May 7, 2020

(54) CAPACITIVE MEASURING METHOD, AND FILLING LEVEL MEASURING DEVICE

(71) Applicant: Endress+Hauser SE+Co. KG, Maulburg (DE)

(72) Inventors: Anna Klara Schneider, Hasel (DE); Raphael Kuhnen, Schliengen (DE); Armin Wernet, Rheinfelden (DE)

(21) Appl. No.: 16/629,442

(22) PCT Filed: Jun. 19, 2018
(86) PCT No.: PCT/EP2018/066292

§ 371 Date: Jan. 8, 2020

(30) Foreign Application Priority Data
Jul. 11, 2017 (DE) 10 2017 115 516.3

(51) Int. Cl. G01F 23/26; G01N 27/22; G01N 27/06

(52) U.S. Cl. CPC G01F 23/266; G01N 27/06; G01N 27/22

(57) ABSTRACT

The present invention relates to a method for capacitive determining and/or monitoring of at least one process variable of a medium as well as to a corresponding apparatus. According to the invention, at least method steps as follows are executed: supplying a probe electrode with at least a first electrical, excitation signal having at least a first predeterminable frequency, receiving a first electrical, received signal from the probe electrode, ascertaining a measured capacitance of the probe electrode or the measured capacitance and a media/accretion resistance of the probe electrode from at least the first received signal, and determining the at least one process variable based on the value of the measured capacitance.

The present invention relates to an apparatus for capacitive determining and/or monitoring of at least one process variable of a medium in a container. The process variable is, for example, a fill level of medium in the container, the electrical conductivity of medium in the container or permittivity of medium in the container. The fill level measurement can be both a continuous fill level determination as well as also the detecting of a predeterminable limit level.

Field devices using the capacitive measuring principle are known per se from the state of the art and are produced by the applicant in many different embodiments and sold, for example, under the marks, Liquicap, Solicap or Liquipoint.

Capacitive fill level measuring devices have, as a rule, an essentially cylindrical sensor unit with at least one sensor electrode, which is introducible at least partially into a container. On the one hand, rod-shaped sensor units extending vertically into the container are widely used, especially for continuous fill level measurement. For detecting a limit level, however, also sensor units introducible into the side wall of a container are known.

During measurement operation, the sensor unit is supplied with an excitation signal, as a rule, in the form of an alternating electrical current signal. From the response signal received from the sensor unit, then the fill level can be determined. Such depends on the capacitance of the capacitor formed by the sensor electrode and the wall of the container, or by the sensor electrode and a second electrode. Depending on the conductivity of the medium, either the medium or an insulation of the sensor electrode forms the dielectric of the capacitor.

For evaluating the response signal received from the sensor unit relative to the fill level, either the so-called apparent electrical current measurement or an admittance measurement can be performed. In the case of an apparent electrical current measurement, the magnitude of the apparent electrical current flowing through the sensor unit is measured. Since the apparent electrical current has, however, an active- and a reactive portion, in the case of an admittance measurement, besides the apparent electrical current the phase angle between the apparent electrical current and the voltage applied to the sensor unit is measured. The additional determining of the phase angle enables, moreover, the providing of information concerning possible accretion formation, such as, for example, known from DE102004008125A1.

Various factors are taken into consideration for choosing the frequency of the excitation signal. On the one hand, the frequency of the applied alternating voltage should because of resonance effects be chosen lower, the longer the sensor unit is. On the other hand, however, basically for all sensor units, the influence of an accretion formation, especially accretion from a conductive medium, lessens with increasing frequency. Entering into this are also influences of the electrical conductivity of the medium.

Known from the state of the art are, on the one hand, capacitive field devices, which are suited for operating at one or a few selected, constant frequencies. The frequencies are, in such case, so selected that the particular frequency is the best possible compromise relative to the above, oppositely moving tendencies. Furthermore, known from DE102011003158A1 is to supply the sensor unit with an excitation signal of variable frequency in the form of a frequency sweep and to select from the response signals belonging to the different frequencies the frequency most suitable for the particular application (medium, embodiment of the sensor unit, etc.).

A problem well known from the state of the art concerning capacitive field devices is the forming of accretion in the region of the sensor unit. Such accretion formation can significantly corrupt the measurement results. For preventing the influence of accretion, on the one hand, an as high as possible frequency can be selected for the excitation signal, since basically the corrupting influence of an accretion decreases with increasing frequency of the excitation signal. An electronics of a corresponding field device suitably designed for high frequencies, is, however, on the one hand, associated with an increased degree of complexity. Moreover, the additional cost factor for the required components is not negligible.

An alternative for preventing the influence of accretion formation on the sensor electrode is the use of a supplemental electrode, especially a so-called guard electrode, such as described, for example, in DE3212434C2. The guard electrode is, in such case, arranged coaxially around the sensor electrode and electrically isolated from such by an insulation. It lies, furthermore, at the same potential as the sensor electrode. The gain in accuracy of measurement by an extra guard electrode depends, however, on the one hand, on the thickness of an accretion layer, as well as on the conductivity of the accretion. Especially in the case of conductive accretions at lower frequencies of the excitation signal, resistive components of the accretion dominate the high-ohm measurement impedance ascertained based on the received signal, based on which impedance the particular process variable is usually determined. Moreover, the effect of the guard electrode is limited by the comparatively high impedance of an insulation capacitance of the measuring probe. Thus, a guard electrode provides, in principle, no constant accuracy of measurement independently of the particular medium and the inclination of the medium for accretion formation, to the extent that high frequencies are avoided for the excitation signal.

Starting from the state of the art, an object of the present invention is, thus, to be able to perform a capacitive determining of a process variable with high accuracy as independently as possible of the particular medium.

The object is achieved by the method as defined in claim 1, as well as by the apparatus as defined in claim 13.

Regarding the method, the object of the invention is achieved by a method for capacitive determining and/or monitoring of at least one process variable of a medium, comprising method steps as follows:
supplying a probe electrode with at least a first electrical, excitation signal having at least a first predeterminable frequency,
receiving a first electrical, received signal from the probe electrode
ascertaining a measured capacitance of the probe electrode or the measured capacitance and a media/accretion resistance of the probe electrode from at least the first received signal, and
determining the at least one process variable based on the value of the measured capacitance.

The probe electrode of a capacitive fill level measuring device is described according to the invention by the measured capacitance and the media/accretion resistance. In the case of a usual apparent electrical current measurement or an admittance measurement, the process variable is ascertained based on the received signal, which has the form of an alternating current. According to the present invention, the process variable is ascertained, in contrast, based on the measured capacitance. Advantageously, the influence of accretion present in the region of the probe electrode on the measured capacitance is negligible, so that a determining of the particular process variable based on the measured capacitance has a significantly lower sensitivity to the presence of accretion. Thus, influences of an accretion can be eliminated, or minimized. Because of the significantly reduced sensitivity of the measuring device to accretion formation, a significantly improved accuracy of measurement can be achieved independently of the particular medium.

The method of the invention can, in such case, be applied to all types of measuring probes suited for the capacitive measuring method. The measuring probe can have both a single probe electrode, wherein a wall of the container is a second electrode, or at least two electrodes. In the latter case, one of the additional electrodes can be, for example, a guard electrode.

The measured capacitance reflects the capacitance between the probe electrode and an additional electrode or the wall of the container. Such measured capacitance is, thus, in principle, the variable dependent on the process variable. The media/accretion resistance includes, in turn, ohmic contributions of the medium and, in given cases, contributions of an accretion, to the extent that such is present. In the case, in which the probe electrode is not covered with medium, the probe electrode is surrounded either by air, when no accretion is present, or by an accretion layer formed by media residues followed by air and the media/accretion resistance is composed of these two components. In the case, in which the probe electrode is, in contrast, covered essentially completely by the medium, a contribution from the accretion usually plays no role, since the measuring probe is in any event covered with the medium. Advantageously, the influence of accretion present in the region of the probe electrode on the measured capacitance is negligible, so that a determining of the particular process variable based on the measured capacitance has a significantly lower sensitivity as regards the forming of accretion. This leads to a significantly improved accuracy of measurement independently of the respective medium.

An embodiment of the method includes that the measured capacitance and/or the accretion/media resistance is ascertained based on an equivalent circuit of the probe electrode, comprising a parallel circuit of the measured capacitance and the media/accretion resistance. Based on the equivalent circuit, then, for example, equations for the measured capacitance and/or the accretion media resistance can be ascertained. Preferably, a formula for determining the measured capacitance does not depend on the accretion/media resistance and vice versa.

An alternative embodiment of the method includes that the measured capacitance and/or the accretion/media resistance is ascertained based on an equivalent circuit of the probe electrode, comprising a series circuit of an insulation capacitance and a parallel circuit of the measured capacitance and the media/accretion resistance. Taking an insulation capacitance of the probe electrode into consideration leads to an additional improvement of the accuracy of measurement. The insulation capacitance can, in such case, be taken as known for calculating the measured capacitance and/or the accretion/media resistance. For example, such can be determined once upon the production of the sensor or upon its delivery, and stored in a memory. The memory can, in such case, be associated with the measurement device, especially with an electronics unit of the measurement device, or even be in an external unit.

An especially preferred embodiment of the method of the invention includes that the probe electrode is supplied with at least the first excitation signal and with a second excitation signal with a second predeterminable frequency, wherein the first received signal and a second received signal are received and wherein the measured capacitance and/or the media/accretion resistance is/are determined from the first and second received signals.

Advantageously, at least one amplitude and/or a phase of at least of the first received signal is/are ascertained, and wherein the measured capacitance and/or the media/accretion resistance is/are determined from the first and second received signals.

For example, the measured capacitance and/or the media/accretion resistance can be determined in the case of a single, first excitation signal based on the amplitude and phase of the first received signal. The same holds for a second excitation signal with a second frequency and the corresponding second received signal. Alternatively, for example, also the amplitudes or phases of at least the first and second received signals can be taken into consideration.

In an embodiment of the method, the at least one process variable is a fill level of medium in a container. It can also be a predeterminable fill level, thus, a limit level. Alternatively, the process variable can, however, also be the electrical conductivity of the medium, or the permittivity of the medium.

In an additional embodiment, a conductivity of the medium is ascertained based on the media/accretion resistance, and/or a permittivity of the medium is ascertained based on the measured capacitance. Based on the permittivity, in turn, also a dielectric constant of the medium can be given. From the conductivity and/or the permittivity, or dielectric constant, of the medium, additional information can be extracted, for example, concerning the process, the type and thickness of an accretion and many other parameters. Advantageously, the method of the invention can be used to determine conductivity of the medium, without an electrically conductive connection to the medium being required.

A preferred embodiment includes that the presence of accretion on at least a portion of the probe electrode can be determined based on the measured capacitance, the media/accretion resistance and/or at least one variable derived from at least the measured capacitance and/or the media/accretion resistance. With the method of the invention thus, it can not only be determined that accretion is present, but, in given cases, also, which type of accretion it is, thus which medium has formed the accretion, or how much accretion has formed.

Another preferred embodiment includes that the maintaining of a recipe of a process running in the container is monitored based on the measured capacitance, the media/accretion resistance and/or at least one variable derived from at least the measured capacitance and/or the media/accretion resistance.

Still another preferred embodiment includes that a mixing of at least a first and a second medium in the container is monitored based on the measured capacitance, the media/accretion resistance and/or at least one variable derived from at least the measured capacitance and/or the media/accretion resistance.

Still another preferred embodiment includes that a cleaning process in the container is monitored based on the measured capacitance, the media/accretion resistance and/or a variable derived from at least the measured capacitance and/or the media/accretion resistance.

Besides the determining and/or monitoring of the particular process variable, thus, supplementally, monitoring of a process running in a container can be performed.

In an embodiment of the method, a degree of coverage of the probe electrode is ascertained. The degree of coverage is, in such case, defined as the ratio of an electrical current tappable from the probe electrode and an electrical current tappable from a guard electrode of the measuring device.

The object of the invention is, moreover, achieved by an apparatus for capacitive determining and/or monitoring of at least one process variable of a medium in a container, comprising
a sensor unit having at least one probe electrode, and
an electronics unit, which electronics unit is embodied to execute at least one method as above described.

In an embodiment of the apparatus, the sensor unit includes two electrodes. By way of example, it can involve an apparatus with two probe electrodes, or an apparatus with a probe electrode and a ground electrode.

Another embodiment includes that one of the electrodes is a guard electrode.

It is to be noted here that embodiments described in connection with the method of the invention can be applied mutatis mutandis also to the apparatus of the invention and vice versa.

The invention will now be described more exactly based on the appended drawing, the figures of which show as follows:

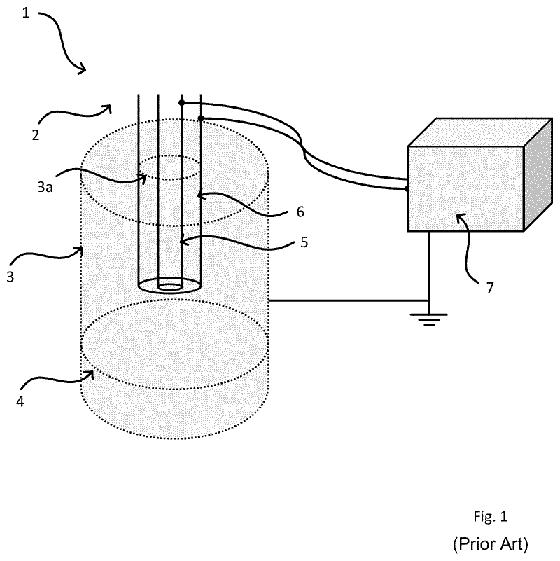

FIG. 1 a schematic view of a capacitive fill level measuring device according to the state of the art,

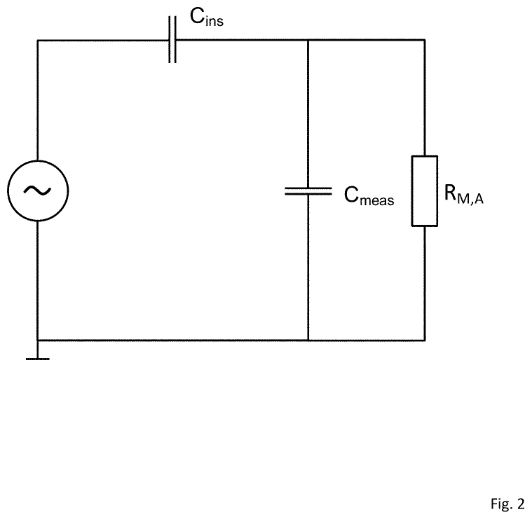

FIG. 2 an equivalent electrical circuit diagram by way of example describing the probe electrode based on the measured capacitance and based on the media/accretion resistance,

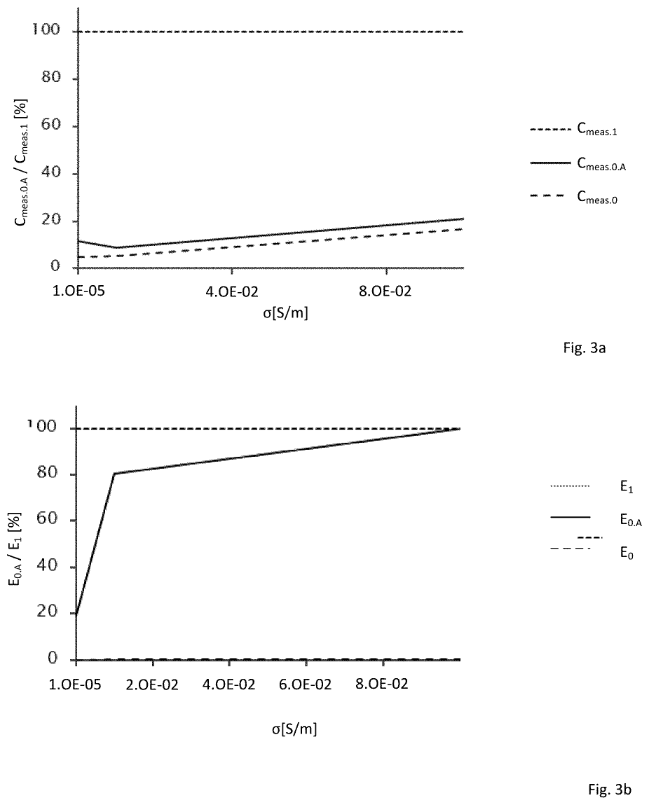

FIG. 3 two graphs illustrating influence of an accretion on (a) the measured capacitance and (b) the amplitude of the received signal, in each case, as a function of conductivity of the medium,

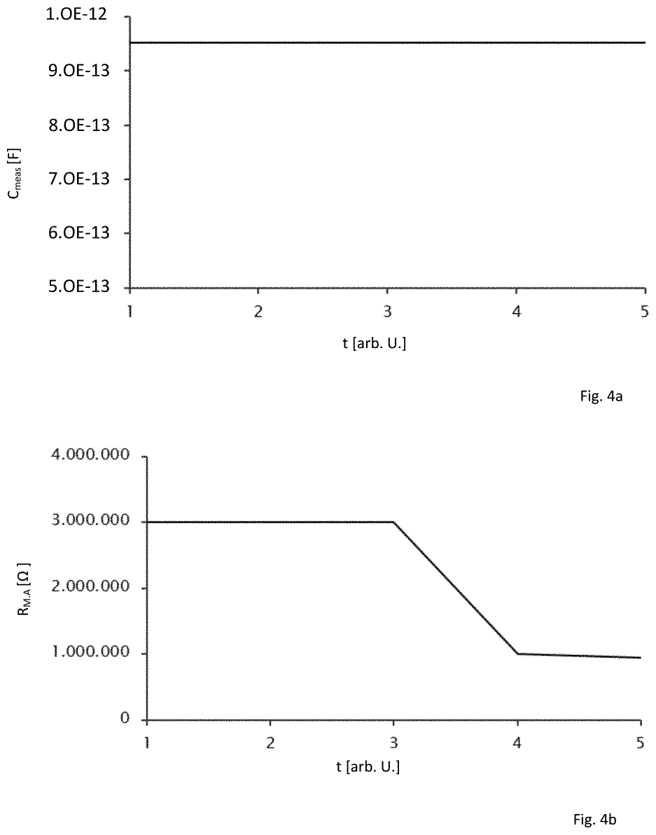

FIG. 4 two graphs illustrating dependence of measured capacitance and accretion/media resistance of an accretion in the region of the probe electrode,

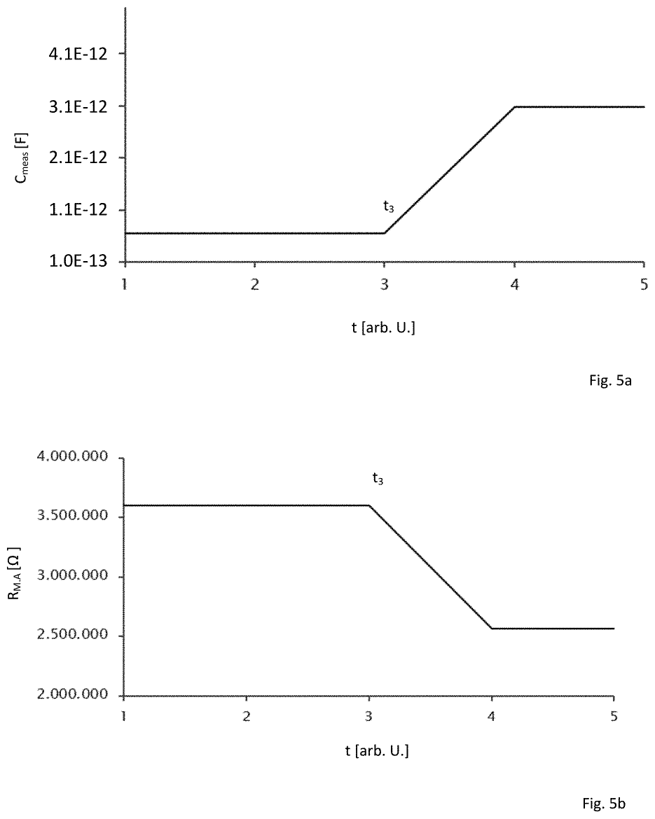

FIG. 5 two graphs illustrating dependence of measured capacitance and accretion/media resistance of a process running in a container, and

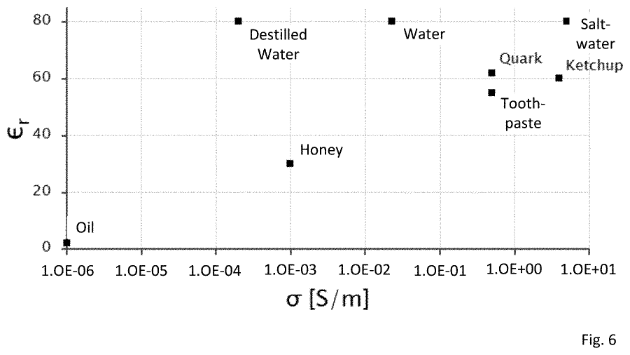

FIG. 6 a graph of dielectric constant and electrical conductivity of various media.

FIG. 1 shows a schematic drawing of a typical field device 1 of the state of the art based on the capacitive measuring principle. The example shows a sensor unit 2 with two cylindrically embodied electrodes 5, 6, which protrude via a process connection 3a from the top inwardly into a container 3 partially filled with medium 4. It is understood, however, that numerous embodiments for a capacitive measuring device with a different number of electrodes are known, which all fall within the scope of the present invention. Besides such measuring devices, in the case of which the sensor unit 2, such as shown in FIG. 1, protrudes from above into the container, the present invention also includes flush sensor units, which essentially terminate with the wall of the container 3, or such sensor units 3, which protrude from a side wall of the container 3 into such.

Sensor unit 2 is composed, in the present example, of a probe electrode 5 and a guard electrode 6 coaxially surrounding the sensor electrode 5 and insulated therefrom. Both electrodes 5, 6 are electrically connected with an electronics unit 7, which is responsible for signal registration,—evaluation and/or—feeding. Especially, the electronics unit 7 determines and/or monitors the fill level of medium 4 in the container 3 based on the response signal received from the sensor unit 2. The extra guard electrode 6 is not necessary for the invention.

For determining the particular process variable, at least the probe electrode 5 is supplied with an excitation signal A and the process variable is ascertained based on the received signal E received from the probe electrode 5. The signals are usually in the form of alternating current. The guard electrode 6 is, in such case, preferably, operated at the same potential as the sensor electrode 5, such as described, for example, in DE 32 12 434 C2.

Independently of the use of a guard electrode 6, varied components contribute to the received signal E and not only the components of the capacitor formed by the probe electrode 5 and a wall of the container 3 or a second electrode, and depending, among other things, on the fill level of medium 4 in the container 3. Rather, also ohmic resistances and numerous other influences play a role. Thus, for example, also an accretion forming at least in the region of the probe electrode 5 will contribute to the received signal E, and this can lead to a lessening of the accuracy of measurement. In the worst case, for example, a fill level of medium 4 in the container 3 can no longer be reliably determined and/or monitored.

According to the invention, thus, not the received signal E itself, but rather the measured capacitance Cₘₑₐₛ of the at least one probe electrode 5 is evaluated. In an equivalent electrical circuit diagram, the probe electrode 5 can be represented, for example, by a series circuit of an insulation capacitance Cᵢₙₛ and a parallel circuit of the measured capacitance Cₘₑₐₛ and the media/accretion resistance R_{M,A}, such as shown in FIG. 2. It is to be noted here that the shown equivalent circuit diagram is only one possible example. Many other versions are possible and fall likewise within the scope of the present invention. For example, in another embodiment, the insulation capacitance Cᵢₙₛ can be omitted.

For determining the measured capacitance Cₘₑₐₛ and/or the media/accretion resistance R_{M,A}, many different methods are possible, which all fall within the scope of the present invention. In the case that the sensor unit 3 is supplied with a single, first excitation signal A₁ with a first frequency f₁, and correspondingly a first received signal E₁ is received, for example, the measured capacitance Cₘₑₐₛ and/or the media/accretion resistance R_{M,A} can be ascertained based on an amplitude a and/or a phase Φ of the first received signal E₁. Alternatively, it is also possible to supply the measuring probe 3 with at least first A₁ and second excitation signals A₂ with at least first f₁ and second frequencies f₂. In such case, the measured capacitance Cₘₑₐₛ and/or the media/accretion resistance R_{M,A} can be determined based on the at least first E₁ and second received signals E₂, for example, from the first a₁ and second amplitudes a₂.

The measured capacitance Cₘₑₐₛ is a measure for the capacitance between the probe electrode 5 and an additional electrode or the wall of the container 3 and, associated therewith, a measure for the particular process variable. Ohmic influences of the medium 4, or a possibly present accretion layer in the region of the probe electrode 5 are, in contrast, taken into consideration using the media/accretion resistance R_{M,A}. In the case, in which the probe electrode 5 is not covered with medium 4, the probe electrode is either surrounded by air, when no accretion is present. Otherwise, the probe electrode 5 is surrounded by an accretion layer formed by media residues followed by air and the media/accretion resistance R_{M,A} is composed of these two components. In the case, in which the probe electrode 5, in contrast, is covered essentially completely by the medium, a contribution from an accretion usually plays no role, since the probe electrode 5 is in any event covered with the medium 4. Advantageously, the influence of accretion present in the region of the probe electrode 5 on the measured capacitance Cₘₑₐₛ is negligible, so that a determining of the particular process variable based on the measured capacitance Cₘₑₐₛ has a significantly lower sensitivity as regards the presence of accretion. This leads to a significantly improved accuracy of measurement independently of the medium 4.

These relationships are illustrated in FIG. 3. In such case, FIG. 3a concerns the measured capacitance Cₘₑₐₛ and FIG. 3b the received signal E. Shown are the measured capacitance C_{meas,0}, and the received signal E₀ for an empty container 4 when no accretion is present, the measured capacitance C_{meas,0,A}, and the received signal E_{0,A} for an empty container 3 when the probe electrode 5 is covered by, for instance, a 1 mm thick accretion layer, and the measured capacitance C_{meas,1}, and the received signal E₁ for a container 3 completely filled with medium 4, in each case, as a function of conductivity a of the medium 4. Shown on the y axis, in such case, is, in each case, the ratio of the contribution from accretion C_{meas,0,A}, or E_{0,A} to the total signal C_{meas,1}, or E₁ in percent. In the case, in which the measured capacitance Cₘₑₐₛ is evaluated, the contribution from a 1 mm thick accretion layer for a typical conductivity range a of a common medium 4 amounts to less than 25%. In the case of evaluating the received signal E as regards the particular process variable, the contribution from the accretion layer rises continuously with the conductivity σ. At a conductivity of σ=800 μS/m, it is no longer possible to distinguish between a completely covered probe electrode 5 and a probe electrode 5 covered with a 1 mm thick accretion layer.

It is thus easy to see that the influence of an accretion in the region of the probe electrode 5 on the particular process variable can be significantly reduced and, in given cases, almost completely eliminated by evaluating the measured capacitance Cₘₑₐₛ instead of the received signal.

Shown in FIG. 4 are the measured capacitance Cₘₑₐₛ and the media/accretion resistance R_{M,A}, in each case, as a function of time in arbitrary units for the case, in which, as time goes on, an accretion forms in the region of the probe electrode 5. The measured capacitance Cₘₑₐₛ shown in FIG. 4a remains essentially constant independently of the presence of an accretion. This makes clear again the increased accuracy of measurement, which can be achieved by evaluating the measured capacitance Cₘₑₐₛ. The media-accretion resistance R_{M,A} is significantly influenced by the forming of an accretion layer and lessens with increasing accretion. By evaluating the measured capacitance Cₘₑₐₛ and/or the media/accretion resistance R_{M,A}, thus, additional information concerning the presence of accretion can be gained. Alternatively, it is also possible to evaluate a variable dependent on the measured capacitance Cₘₑₐₛ and/or the media/accretion resistance R_{M,A}, for example, a ratio of the measured capacitance Cₘₑₐₛ and the media/accretion resistance R_{M,A}.

Based on an evaluation of the measured capacitance Cₘₑₐₛ and/or of the media/accretion resistance R_{M,A}, furthermore, information can be issued concerning the medium 4 located in the container 3. Thus, in principle, a monitoring of a process running in the container 3 can be performed. Analogous considerations hold for the case, in which a cleaning process of the container 3 is to be monitored. Such is illustrated in FIG. 5 based on the measured capacitance Cₘₑₐₛ and the media/accretion resistance R_{M,A}, in each case, as a function of time in arbitrary units, for the case, in which the medium 4 located in the container 3 changes at the time t₃. Both the measured capacitance Cₘₑₐₛ shown in FIG. 5a as well as also the media-accretion resistance R_{M,A} shown in FIG. 5b show a clear dependence on the particular medium 4 located in the container 3. By evaluating the measured capacitance Cₘₑₐₛ and/or the media/accretion resistance R_{M,A}, thus, additional information concerning the particular process can be generated. Alternatively, it is, such as in the case of FIG. 4, also possible to evaluate a variable dependent on the measured capacitance Cₘₑₐₛ and/or the media/accretion resistance R_{M,A}, for example, a ratio of the measured capacitance Cₘₑₐₛ and the media/accretion resistance R_{M,A}.

Shown in FIG. 6, finally, are the conductivities a and dielectric constants εᵣ of various common media 4. With the help of an evaluating of the measured capacitance Cₘₑₐₛ and the media/accretion resistance R_{M,A} in an additional embodiment of the present invention, information concerning media 4 located in the container can be gained. For example, for determining the dielectric constant εᵣ of a medium 4, first the measured capacitance Cₘₑₐₛ can be determined when the container 3 is empty. For an empty container 3, it should be the case that εᵣ≈1. If one then determines supplementally the measured capacitance Cₘₑₐₛ in the case of a container 3 completely filled with the medium 4, then one can ascertain the dielectric constant εᵣ of the medium 3. In analogous manner, likewise the conductivity a of a medium 3 can be ascertained.

1-15. (canceled)

16. A method for capacitive determining and/or monitoring of a process variable of a medium, comprising:
supplying a probe electrode with a first electrical, excitation signal having a first predeterminable frequency;
receiving a first electrical, received signal from the probe electrode;
ascertaining a measured capacitance of the probe electrode or the measured capacitance and a media/accretion resistance of the probe electrode from the first received signal; and
determining the process variable based on the measured capacitance.

17. The method as claimed in claim 16, further comprising:
determining an equivalent circuit of the probe electrode, wherein the equivalent circuit includes a parallel circuit of the measured capacitance and the media/accretion resistance,
wherein the ascertaining of the measured capacitance and/or of the accretion/media resistance is based on the equivalent circuit.

18. The method as claimed in claim 16, further comprising:
determining an equivalent circuit of the probe electrode, wherein the equivalent circuit includes a series circuit from an insulation capacitance and a parallel circuit of the measured capacitance and the media/accretion resistance,
wherein the ascertaining of the measured capacitance and/or of the accretion/media resistance is based on the equivalent circuit.

19. The method as claimed in claim 16, further comprising:
supplying the probe electrode with a second electrical, excitation signal having a second predeterminable frequency; and
receiving a second electrical, received signal from the probe electrode,
wherein the ascertaining of the measured capacitance and/or of the media/accretion resistance is based on the first and the second received signals.

20. The method as claimed in claim 16, further comprising:
ascertaining an amplitude and/or a phase of the first received signal,
wherein the ascertaining of the measured capacitance and/or of the media/accretion resistance is based on the amplitude and/or the phase of the first received signal.

21. The method as claimed in claim 16, wherein the process variable is a fill level of the medium in a container.

22. The method as claimed in claim 16, further comprising:
ascertaining a conductivity of the medium based on the media/accretion resistance; and/or
ascertaining a permittivity of the medium based on measured capacitance.

23. The method as claimed in claim 16, further comprising:
determining a presence of accretion on at least a portion of the probe electrode based on the measured capacitance, the media/accretion resistance and/or at least one variable derived from at least the measured capacitance, and/or the media/accretion resistance.

24. The method as claimed in claim 16, further comprising:
monitoring a maintaining of a recipe of a process running in the container, wherein the monitoring is based on the measured capacitance, the media/accretion resistance and/or at least one variable derived from at least the measured capacitance, and/or the media/accretion resistance.

25. The method as claimed in claim 16, further comprising:
monitoring a mixing of at least a first and a second medium in a container, wherein the monitoring is based on the measured capacitance, the media/accretion resistance and/or at least one variable derived from at least the measured capacitance and/or the media/accretion resistance.

26. The method as claimed in claim 16, further comprising:
monitoring a cleaning process in the container, wherein the monitoring is based on the measured capacitance, the media/accretion resistance and/or a variable derived from at least the measured capacitance, and/or the media/accretion resistance.

27. The method as claimed in claim 16, further comprising:
ascertaining a degree of coverage of the probe electrode.

28. An apparatus for capacitive determining and/or monitoring of at least one process variable of a medium in a container comprising:
a sensor unit having at least one probe electrode; and
an electronics unit embodied to:
supply the at least one probe electrode with a first electrical, excitation signal having a first predeterminable frequency;
receive a first electrical, received signal from the at least one probe electrode;
ascertain a measured capacitance of the at least one probe electrode or the measured capacitance and a media/accretion resistance of the at least one probe electrode from the first received signal; and
determine the at least one process variable based on a value of the measured capacitance.

29. The apparatus as claimed in claim 28, wherein the sensor unit includes at least two electrodes.

30. The apparatus as claimed in claim 29, wherein one of the electrodes is a guard electrode.
